(19) United States
(12) Patent Application Publication
(10) Pub. No.: US 2013/0076286 A1
(43) Pub. Date: Mar. 28, 2013

(54) REDUCING TONAL EXCITATIONS IN A COMPUTER SYSTEM

(71) Applicants: Brad Lee PATTON, Campbell, CA (US); Anthony J. Aiello, Santa Cruz, CA (US); Cheng P. Tan, Fremoent, CA (US)

(72) Inventors: Brad Lee PATTON, Campbell, CA (US); Anthony J. Aiello, Santa Cruz, CA (US); Cheng P. Tan, Fremoent, CA (US)

(73) Assignee: Apple Inc., Cupertino, CA (US)

(21) Appl. No.: 13/623,039

(22) Filed: Sep. 19, 2012

Related U.S. Application Data
(60) Provisional application No. 61/568,100, filed on Dec. 7, 2011.
(60) Provisional application No. 61/460,772, filed on Sep. 23, 2011.

(51) Int. Cl. G05D 23/00; H02P 7/00

(52) U.S. Cl. 318/460; 318/471

(57) ABSTRACT

The described embodiments relate generally to control of rotational components in a computer system. In one embodiment, the rotational component includes a cooling fan, the cooling fan being controlled in accordance with data tailored to reduce the acoustic noise produced by the cooling fan. In one embodiment, the cooling fan is operated with non-uniform pulse width modulated signals. The non-uniform pulse width modulated signals can be a function of desired rotation speed and can include fundamental and harmonic components.

### CROSS REFERENCE TO RELATED APPLICATIONS

This U.S. patent application claims priority under 35 USC 119(e) to U.S. Provisional Patent Application No. 61/568,100 filed Dec. 7, 2011 entitled “Reducing Tonal Excitations in a Computer System” by Patton et al. and to U.S. Provisional Patent Application No. 61/460,772 filed Sep. 23, 2011, entitled “Identification of Critical Frequencies of a Cooling Fan and Methods for Circumventing Frequency Excitations in a Computer System” by Tan et al., both of which are incorporated by reference in their entirety for all purposes.

### FIELD OF THE DESCRIBED EMBODIMENTS

The described embodiments relate generally to reducing acoustic noise in computing systems. In particular, methods to operate cooling fans in a manner that can reduce relative tone strength in a computer system are described.

### RELATED ART

One common way to facilitate heat removal from computers is to introduce cooling fans that circulate air into and out of a computer enclosure. Cooling fans were originally designed to simply run the entire time the computer was on. While this made for a predictable, and continuous operating state, it was not energy efficient and resulted in the creation of unnecessary noise and vibrations. In a slightly more advanced configuration, the fan could be switched between on and off states whenever the internal temperature of the computer enclosure exceeded a certain threshold temperature. Further innovations brought Pulse Width Modulation (PWM) control to cooling fans. PWM controllers change the speed of direct current (“DC”) cooling fan motors by modulating an input voltage, which may be represented as a periodic rectangular wave having an alternating sequence of on-time and off-time. The fraction of time that the signal is active equates to the duty cycle of the PWM signal. For example, where the on-time pulse duration (t) is 0.5 seconds and the period (T) of the PWM signal is 1 second, the duty cycle is 50 percent. In this way, fan speed can be modulated between a numbers of speeds which allows a cooling system to more efficiently regulate the internal temperature of a computer system. At low enough rotational speeds fan operation might not even be noticeable to the end user of a computer system. While the speed modulation capability allowed by PWM controllers does allow cooling to take place much more efficiently, the high number of different potential frequencies can increase the possibility of at least one cooling fan operating at a speed that produces acoustic noise above an acceptable level. In particular, PWM controllers can effectively drive a cooling fan slowly and create a relatively low overall acoustic noise. However, there can be one or more frequencies or tones related to cooling fan speed that are relatively strong despite the low overall noise level. These tones can be distracting due to the low overall noise level.

Therefore, what is desired is a reliable approach to identify and reduce acoustic noise which can adversely affect the overall user experience, while maintaining an efficient cooling environment for the computer components.

### SUMMARY

This paper describes various embodiments that relate to computing systems and more particularly to cooling computer systems in a manner that can reduce related fan noise. A method for operating a computer system including an electro-mechanical component such as a fan can include the steps of characterizing an operation of the electro-mechanical component when operated with a first signal, and modifying the first signal to produce a second signal such that when operating the electro-mechanical component with the second signal, a prominent acoustic tone is produced that is less than a predetermined threshold.

In another embodiment, a fan controller for controlling a cooling fan for a computing system can include a temperature sensor, a look up table for storing non-uniform pulse width modulated (PWM) waveform parameters, an address generator configured to control the look up table by providing address inputs; a digital to analog converter coupled to the look up table and configured to provide non-uniform PWM fan control signals and a controller configured to determine the non-uniform PWM fan control signals in response to a determined temperature.

In still another embodiment, a computer system including a non-uniform PWM fan controller can include a temperature sensor to determine the temperature of the computer system, a cooling fan for cooling the computer system and a fan controller configured to control the cooling fan with non-uniform PWM fan signals in response to a determined temperature of the computer system.

In yet another embodiment, computer code for controlling a cooling fan in a computing system can include code for determining the temperature of the computing system, computer code for selecting parameters for a non-uniform PWM waveform in response to temperature, computer code for generating a non-uniform PWM waveform in accordance with the selected parameters and computer code for operating the cooling fan with the generated non-uniform PWM waveform such that the cooling fan produces prominent acoustic tones less than a predetermined threshold.

### BRIEF DESCRIPTION OF THE DRAWINGS

The described embodiments and the advantages thereof may best be understood by reference to the following description taken in conjunction with the accompanying drawings. These drawings in no way limit any changes in form and detail that may be made to the described embodiments by one skilled in the art without departing from the spirit and scope of the described embodiments.

FIG. 1 is a prior art diagram of a simplified view of a fan motor.

FIG. 2 shows the relationship of three commutation phases to each other 200 in a prior art configuration.

FIG. 3 shows prior art waveforms that can be associated with a fan motor.

FIG. 4 shows a flowchart describing a process for characterizing a computer system.

FIG. 5 shows a computer system diagram describing a fan controller according to one embodiment described in the specification.

FIG. 6 shows waveforms for reducing acoustic noise emitted from a cooling fan in accordance with one embodiment described in the specification.

FIG. 7 is a flowchart describing a process for determining non-uniform PWM waveforms for a cooling fan.

FIG. 8 is a flowchart describing another process for determining PWM waveforms for a cooling fan.

FIG. 9 is a flowchart describing a process for determining non-uniform PWM waveforms for cooling fan, particularly when the characteristics of the cooling fan are unknown.

FIG. 10 is a block diagram of one embodiment of a fan controller in accordance with the specification.

FIG. 11 shows a flowchart describing a process in which one or more of the embodiments of the described embodiments can be applied to a computer system.

FIG. 12 is a block diagram of an electronic device suitable for controlling some of the processes in the described embodiment

### DETAILED DESCRIPTION OF EXAMPLE EMBODIMENTS

Representative applications of methods and apparatus according to the present application are described in this section. These examples are being provided solely to add context and aid in the understanding of the described embodiments. It will thus be apparent to one skilled in the art that the described embodiments may be practiced without some or all of these specific details. In other instances, well known process steps have not been described in detail in order to avoid unnecessarily obscuring the described embodiments. Other applications are possible, such that the following examples should not be taken as limiting.

In the following detailed description, references are made to the accompanying drawings, which form a part of the description and in which are shown, by way of illustration, specific embodiments in accordance with the described embodiments. Although these embodiments are described in sufficient detail to enable one skilled in the art to practice the described embodiments, it is understood that these examples are not limiting; such that other embodiments may be used, and changes may be made without departing from the spirit and scope of the described embodiments.

Computer systems generally incorporate a number of components some of which can generate unwanted noise. Components such as optical disc drives (ODD), hard disk drives (HDD) and cooling fans are examples of such components. Cooling fans in particular are a leading cause of noise in modern computer systems. When these cooling fans are driven at a number of different speeds, it becomes increasingly likely for them to produce sufficient noise to become a distraction to a user. Often, acoustic energy of the noise may not be evenly distributed, but rather can be distributed such that one or more frequencies or tones can be relatively strong within a frequency band of interest. Such tones can be a function of fan construction (such as the number of poles in the magnet and the number of slots on the stator), but other factors can also affect the strength of the tones such as computer system construction or system component placement. A frequency signature can show the relationship between an acoustic energy level and a frequency. A frequency signature can cover a range of frequencies, for example from 100 Hz to 15,000 Hz. Thus, strong tones can manifest themselves on the frequency signature as acoustic energy peaks associated with particular frequencies.

Computer systems often control the fan speeds to respond to environmental conditions. For example, as the computer temperature increases, fan speed can increase to proportionally increase airflow and cool computer components. This may enhance the user experience by allowing lower fan speeds and accordingly lower amounts of related fan noise. However, as fan speed decreases, the fan can produce certain tones with sufficient energy to become a distraction to the user. Fan motor noise can be more evident at slower fan speeds since the overall air flow noise can be relatively lower. Furthermore, these tones are a function of fan speed. That is, as fan speeds change, the frequencies of the motor-related prominent tones change proportionally.

Unfortunately due to system-to-system variation as well as potentially different system (fan) components, designing the computer system to reduce the fan noise in general, and the amplitude of prominent tones in particular, can be difficult and can increase production costs. To further complicate matters, computer systems can be modified by an end-user after production. For example, fan components can be replaced to affect a repair (fan failure). Designing a computer system to have a relatively broadband ability to reduce a broad spectrum fan noises from multiple cooling fan models or manufacturers can be difficult.

Even one particular fan model from one particular manufacturer may not exhibit consistent acoustic properties from unit to unit. Fans can be subject to manufacturing tolerances that can change the relationship of bearings, magnets, stators etc. to each other such that the frequency signature for any particular fan speed can change. Also, the tooling used by a fan manufacturer can wear over time and cause the frequency signature to vary or shift.

Unfortunately, however, accurate identification of prominent tones within the frequency signature can require analysis that can be quite lengthy and complex.

In order to overcome these obstacles, a testing regime can require at least cycling the cooling fans through most or all potential operating speeds in the computer system. Once a frequency signature is captured, any prominent tones can be identified, and controller circuitry (such as a fan controller) can be directed to operate the cooling fans in such a way as to reduce the relative amplitude of the prominent tones. If during testing, a method of cooling fan operation is determined that produces relatively less noise, then the method of fan operation can be stored in memory. Thus, during operation, for any given desired fan speed, the fan controller can look up the related fan operation characteristics and operate the fans in a predetermined manner to produce less noise.

The operation of fan components can have a tendency to change as they operate. For example, a cooling fan can operate at slightly different speeds as components deteriorate such as bearing wear; lubrication break down, etc., thus shifting the entire performance curve. For example, as the cooling fans age and mechanical wear increases and lubrication decreases, friction between the fan bearings can result in a slight slowing the fan speed in relation to that expected by the fan controller. For example, without taking any wear related performance issues into account, the fan controller can direct the fan to operate with a first operational setting that can normally produce less noise. However, due to the age based slowing of the fan assembly, the fan can actually operate at a reduced fan speed resulting in production of relatively more noise. For at least this reason, periodically updating the fan operation profile of the computer system can be very useful.

Many computer systems include sensors that can be employed by the user for various applications. For example, an integrated microphone can be used in a communication application. In one embodiment, the integrated microphone can be used to detect the acoustic noise and produce frequency signatures. In still other embodiments, the sensors can be bench test type sensors that can be used to create frequency signatures for a representative computer system.

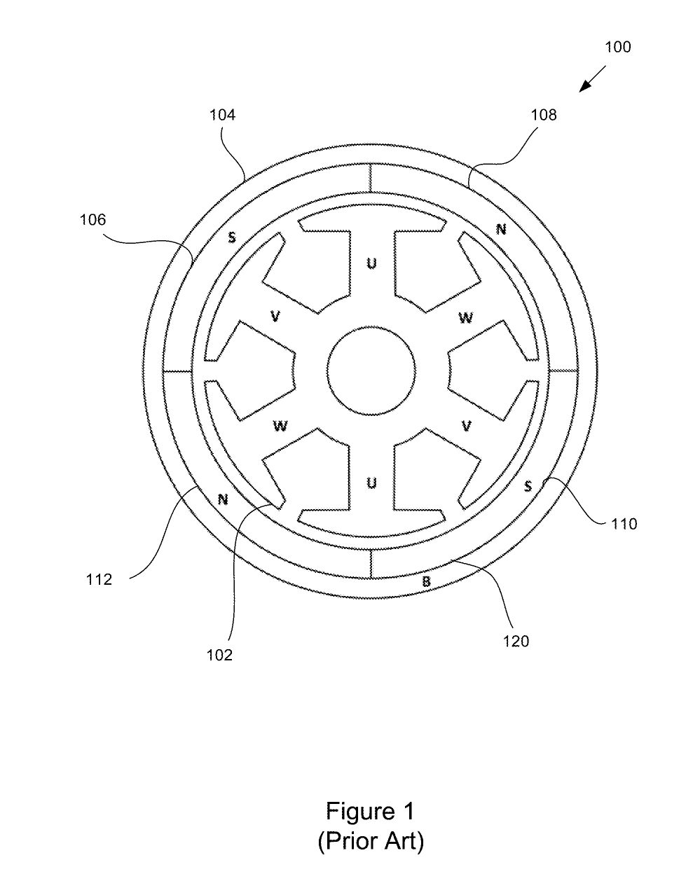

FIG. 1 is a prior art diagram of a simplified view of a fan motor 100. In one embodiment, the fan motor 100 can include a stator 102, magnet 120 (including poles 106, 108, 110 and 112) and a back-iron ring 104. Stator 102, as shown, includes six teeth, pairs of which can form each of three phases (labeled U, V and W). Each phase can be wound with insulated magnet wire around a stem portion of the teeth indicated by the labeled locations (U, V, W; magnet wire not shown in FIG. 1). The stator 102 can be made from a laminated stack of silicon steel sheets, insulated to reduce losses. The back-iron ring 104 can act as a flux return path and can be made of ferromagnetic steel. The magnet 120 can include 4 poles alternating between north and south. In this example, poles 108 and 112 can be north poles and poles 106 and 110 can be south poles.

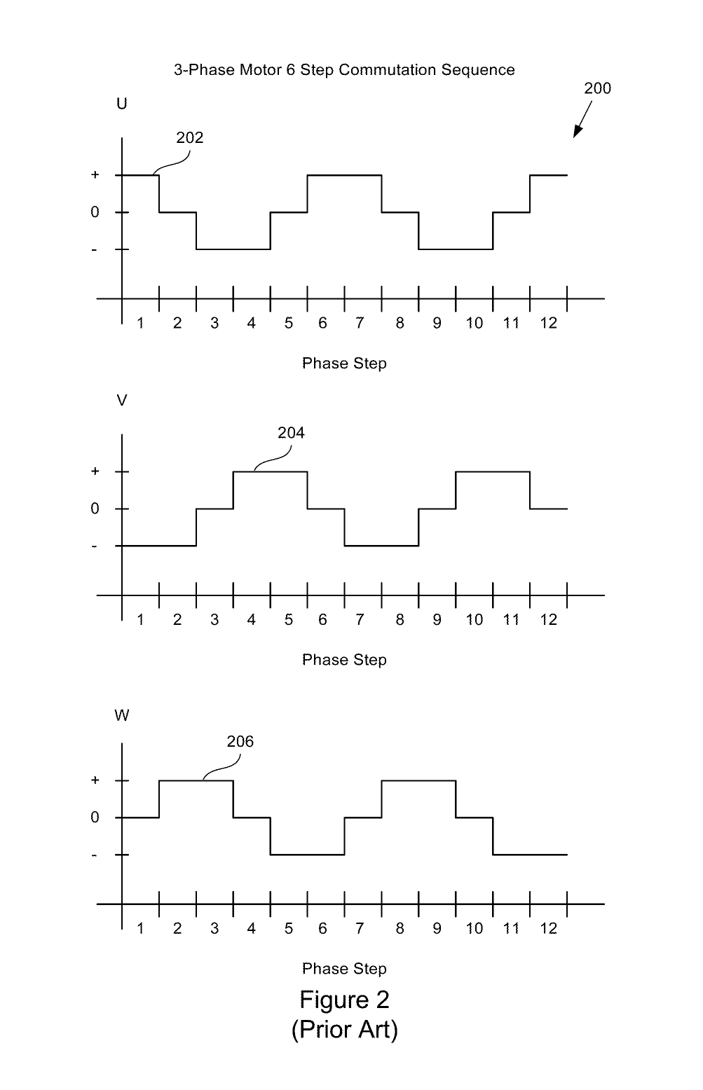

When a pair of phases is energized with current through the magnet wire, a magnetic field is generated through the stem portion of the stator 102, across an air gap, through the magnet 120, passes within the back-iron ring 104 and returns through adjacent teeth of the stator 102, completing a magnetic circuit. The current-induced magnetic field interacts with the magnet field, causing magnet 120 to move in relation to stator 102. Switching the current applied to winding phases according to a commutation sequence (shown in FIG. 2) can result in proper rotation of the magnet 120. If a fan impeller is attached to the magnet 120, then the fan impeller can be caused to rotate when the commutation sequence is applied to wires wound around the stator teeth.

A commutation sequence can be a six step process with phase pairs substantially energized in the following sequence:
1)+U, −V
2)+W, −V
3)+W, −U
4)+V, −U
5)+V, −W
6)+U, −W
   A “+” can indicate current flowing in a first direction within the magnet wire associated with one phase (i.e., two associated teeth in stator 102). Conversely, a “−” can indicate a current flowing in a second or opposite direction with respect to the first direction.

FIG. 2 shows the relationship of commutation of the three phases to each other 200 in a prior art configuration. The U phase commutation sequence is shown by curve 202. Similarly, the V phase commutation sequence can be shown by curve 204 and the W phase commutation sequence can be shown by curve 206. In this example, the motor illustrated in FIG. 1 can be controlled with a 6 step sequence. As shown in FIG. 2, in the first commutation-step, the U phase stator windings can receive a positive (+) current and the V phase stator windings can receive a negative (−) current. The W phase stator windings can receive no current. In commutation-step 2, the V phase stator windings can receive a negative (−) current and the W phase stator windings can receive a positive (+) current. The U phase stator windings can receive no current. FIG. 2 goes on to describe the remaining four phase-steps, which then repeat continuously. Other commutation sequences and waveforms are possible and commonly known.

As the commutation sequence of FIG. 2 causes the magnet 120 to rotate, the poles (106-112) of the magnets pass the stator 102 teeth and can experience oscillating attraction forces that can generate vibration and acoustic noise at specific frequencies that can be multiples of the number of stator 102 slots and/or the number of magnet poles (106-112) and the rotating speed. The noise can be referred to as pure tones or prominent tones. The attraction forces can act in axial and radial directions, as well as in the circumferential direction in the form of torque fluctuations.

The rise and fall of the current in the windings around stator 102 teeth can be influenced by shape of the voltage PWM waveform that is applied to the windings, thus influencing a magnetic field waveform shape that interacts with the magnet poles to rotate the fan.

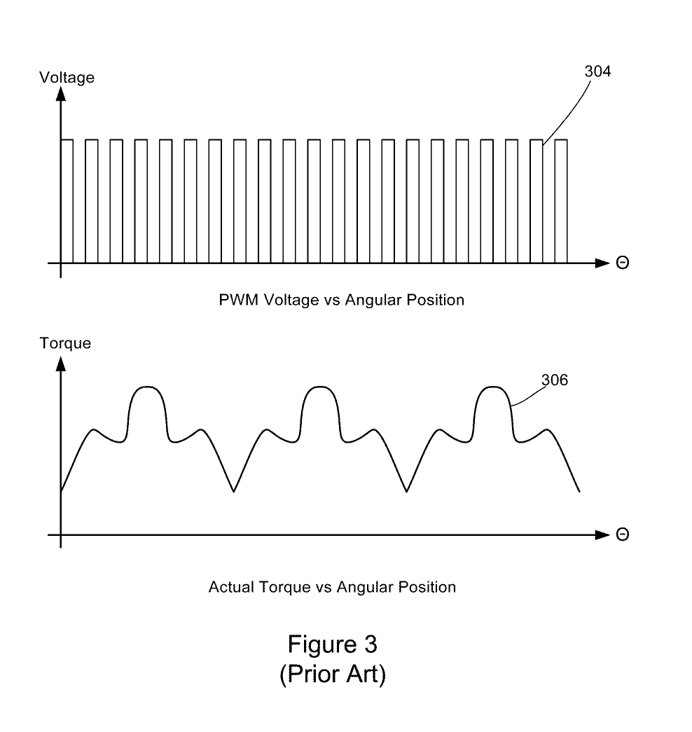

FIG. 3 shows prior art waveforms 304 and 306 that can be associated with fan motor 100. Voltage waveform 304 shows a regular pulse width modulated (PWM) waveform that can be used to deliver current to stator 102 windings. A PWM waveform is often used to control fan motors as a means to vary the speed of the fan motor 100. By changing a duty cycle of the PWM waveform, fan motor speed can be made to vary. Although the voltage waveform 304 can be uniform and regular, the resulting torque curve 306 can be irregular and generally non-smooth. As described above, the torque curve 306 can be a result of stator 102 configuration, magnetization waveform shape of magnet 120 and rotating speed. The non-smooth torque curve 306 can generate acoustic and vibrational noise; in particular, torque curve 306 can include harmonic frequencies, which can generate acoustic noise in the form of narrow band tones (i.e., prominent tones).

One approach to reducing acoustic and vibrational noise from a fan motor 100 is to smooth the related torque curve. In one embodiment, a system can be characterized to determine acoustic noise associated with different fan motor operating points. Component operation can be adjusted or modified at particular operating points to smooth a torque curve of a fan. One approach to smooth the related torque curve can include shaping a PWM waveform.

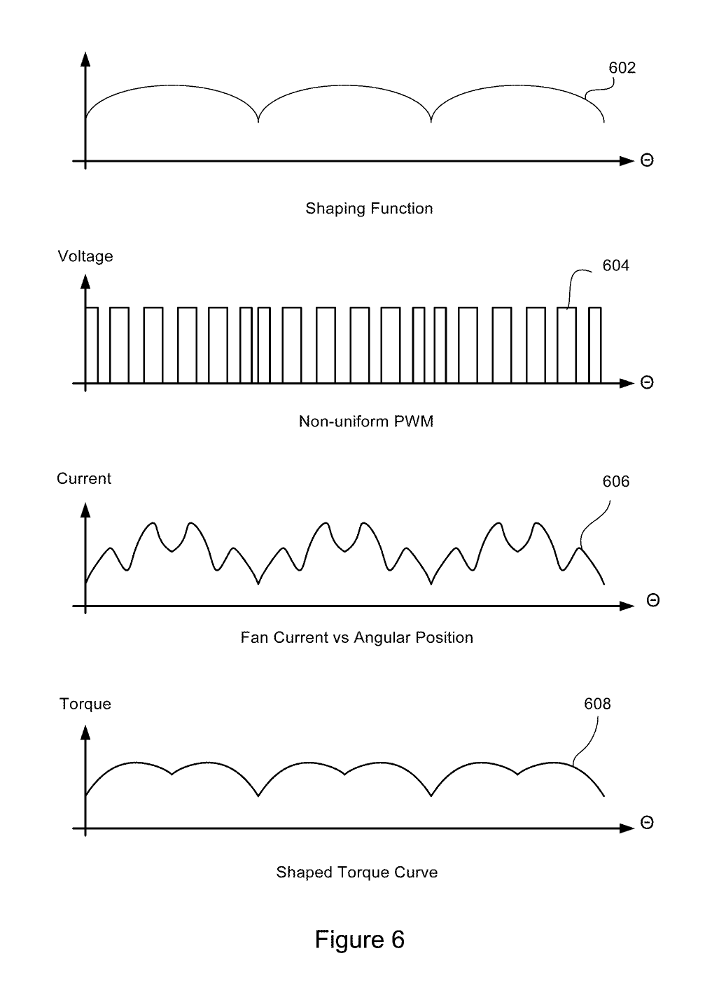

In one embodiment, the shape of the PWM voltage waveform can be defined by a set of parameters as described in the equations described below in conjunction with FIG. 6. In one embodiment, unwanted vibration forces can be effectively cancelled or attenuated. Other types of motors (other than multi-phase fan motors) can also be driven in a similar manner to reduce vibration and acoustic noise associated with the stator-magnet interaction, including single-phase motors, other slot-pole combinations, and various other types of motors known to those skilled in the art.

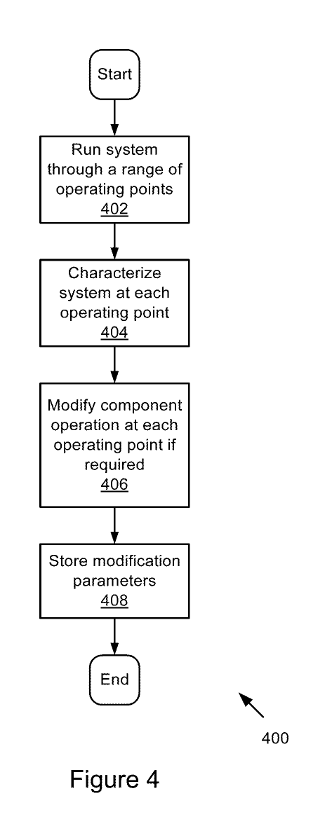

FIG. 4 shows a flowchart 400 describing a process for characterizing a computer system and adjusting the operation of at least one component in the computer system to improve operation. The process begins at 402 where the computer system is operated at different operation points. In one embodiment, the computer system can include at least one cooling fan and the different operation points can be different cooling fan speeds. At 404, the computer system can be characterized at each operating point. In one embodiment, a frequency signature can be captured to characterize the acoustic noise (particularly the cooling fan noise) of the computer system, such as through an FFT (Fast Fourier Transform) of a sound clip capture by a microphone. At 406, component operation can be modified if the characterization result is not acceptable. In one embodiment, if the frequency signature indicates that the cooling fan is producing one or more tones greater than a threshold, then the cooling fan operation can be modified to reduce those tones. At 408, the modified component operation can be stored. In one embodiment, modified component operation for each operating point can be stored in memory for later retrieval.

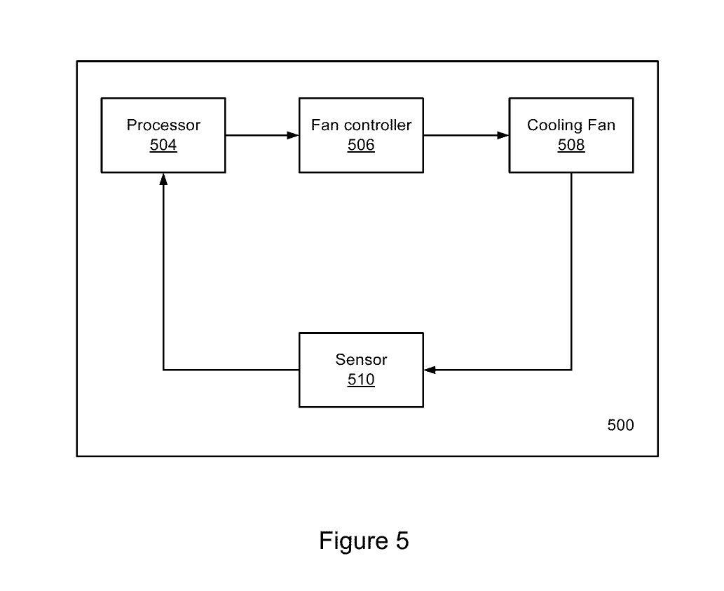

FIG. 5 shows a computer system diagram describing a fan controller according to one embodiment described in the specification. At least one temperature sensor 510 is positioned inside computer system enclosure 500. Generally shortly after the computer system is started up, temperature sensor 510 alerts processor 504 when computer system enclosure 500 has exceeded a certain threshold temperature value. Processor 504 can have a table of values that is used to then determine what speed to drive the fan at in order to keep the computer system components at a safe temperature level. Fan controller 506 can be used to drive at least one cooling fan 508. In one embodiment, the fan controller 506 can take the form of a Pulse Width Modulation (PWM) controller. In this embodiment, the table of values can also include information regarding how to particularly adjust the PWM controller parameters to drive the cooling fan 508 to operate more quietly. In any case, fan controller 506 can be directed by processor 504 arranged to execute instructions stored in a local memory device, not shown. The operating instructions can include data that can be used by the processor 504 to direct fan controller 506 to drive cooling fan 508 in such a manner that avoids excessive noise. In this way, the operation of the cooling fan 508 can be tailored for a specific operation regime of the computer system, specific environmental conditions, and power conditions, to name only a few.

When fan controller 506 takes the form of a PWM controller, adjustment of the speed of cooling fan 508 can be accomplished by, among other things, varying the duty cycle of the voltage entering cooling fan 508. Once cooling fan 508 reduces the internal temperature of computer system enclosure 500, temperature sensor 510 can detect a current system temperature (or at least the temperature in the vicinity of a temperature sensitive component) and that is then reported to processor 504. If the current system temperature is determined to be within an acceptable range of operating temperatures, processor 504 can direct PWM controller 506 to maintain or even reduce the speed of cooling fan 508. Therefore, the feedback loop between temperature sensor 510 and PWM controller 506 can result in a large number of potential operating states of the cooling fan 508. Each operating state can have associated with it a particular profile for the PWM controller 506. In this way, operation of the cooling fan 508 can be managed to reduce the amount of generated acoustic noise.

Changing the voltage (and hence the current) delivered to the cooling fan 508 can change the torque curve realized by the cooling fan 508. Delivering the current in a non-uniform manner can alter the torque curve by, at least in part, compensating for the uneven actual torque curve (i.e., waveform 306). The current delivered to the cooling fan 508 can be shaped by changing the PWM signal from the fan controller 506.

FIG. 6 shows waveforms for reducing acoustic noise emitted from a cooling fan 508 in accordance with one embodiment described in the specification. Waveform 602 can illustrate one embodiment of a shaping function. The shaping function can be used to direct fan controller 506 to shape a voltage waveform to drive cooling fan 508. For example, fan controller 506 can create a non-uniform PWM waveform in accordance with a shaping function defined by waveform 602. Waveform 604 shows one example of a non-uniform PWM waveform that can be derived from a shaping function similar to the one illustrated by waveform 602. The non-uniform PWM waveform can enable a non-uniform current delivery which may in turn affect an actual torque curve from the cooling fan 508.

The non-uniform PWM waveform shown in waveform 604 can generate a shaped current waveform as shown by waveform 606. The shaped current waveform 606 can produce a modified torque curve when applied to the DC cooling fan. The resulting torque curve can be made relatively smoother as shown in waveform 608 especially compared to torque curve 306 in FIG. 3.

In one embodiment, the non-uniform PWM waveform (such as waveform 604) can be determined by applying shaping function 602 the following equations.

$$\begin{matrix}f ( t ) = \vert sin ( 3 \cdot 2 π \cdot \frac{{F}_{s} \cdot t}{{N}_{d}} ) \vert + {A}_{RM S} \\ where \text{:} \\ Nd = number of driver steps \\ {F}_{s} = switching frequency = {N}_{POLES} {N}_{SLOTS} \frac{ω fan}{2 π} \\ {ω}_{fan} is the fan speed in radians \text{/} sec \\ {N}_{POLES} is the number of magnet poles \\ {N}_{SLOTS} is the number of slots in the stator . & ( eq . 1 ) \\ {A}_{RM S} = RootMeanSquare of \vert sin ( 3 \cdot 2 π \cdot \frac{{F}_{s} \cdot t}{{N}_{d}} ) \vert & ( eq . 2 )\end{matrix}$$

Equations 1 and 2 can be applied to three phase cooling fans (such as the one shown in FIG. 1). In one embodiment, the PWM waveform can be made more complex such that different harmonics of the basic sine wave can be added to formulate the PWM waveform. This is shown in equation 3 below.

$$\begin{matrix}f ( t ) = \vert sin ( 3 \cdot 2 π \cdot \frac{{f}_{s} \cdot t}{{N}_{d}} ) \vert + {\sum }_{n = i} {A}_{n} \vert sin ( 3 \cdot 2 π \cdot n \cdot \frac{{F}_{s} \cdot t}{{N}_{d}} ) \vert {A}_{RM S} \\ where \text{:} \\ n = harmonic numbers ( i . e . 3 , 5 , 7 , 9 … ) & ( eq . 3 ) \\ {A}_{RM S} = RMS \vert sin ( 3 \cdot 2 π \cdot \frac{{F}_{s} \cdot t}{{N}_{d}} ) \vert + {\sum }_{n = i} {A}_{n} \vert sin ( 3 \cdot 2 π \cdot n \cdot \frac{{F}_{s} \cdot t}{{N}_{d}} ) \vert & ( eq . 4 )\end{matrix}$$

The number of harmonics to be considered can be limited to a reasonable number since the lower ordered harmonics may have the greatest affect on the final waveform. Aₙ can be a scaling factor allowing the related harmonics to have greater or lesser effect on the final waveform.

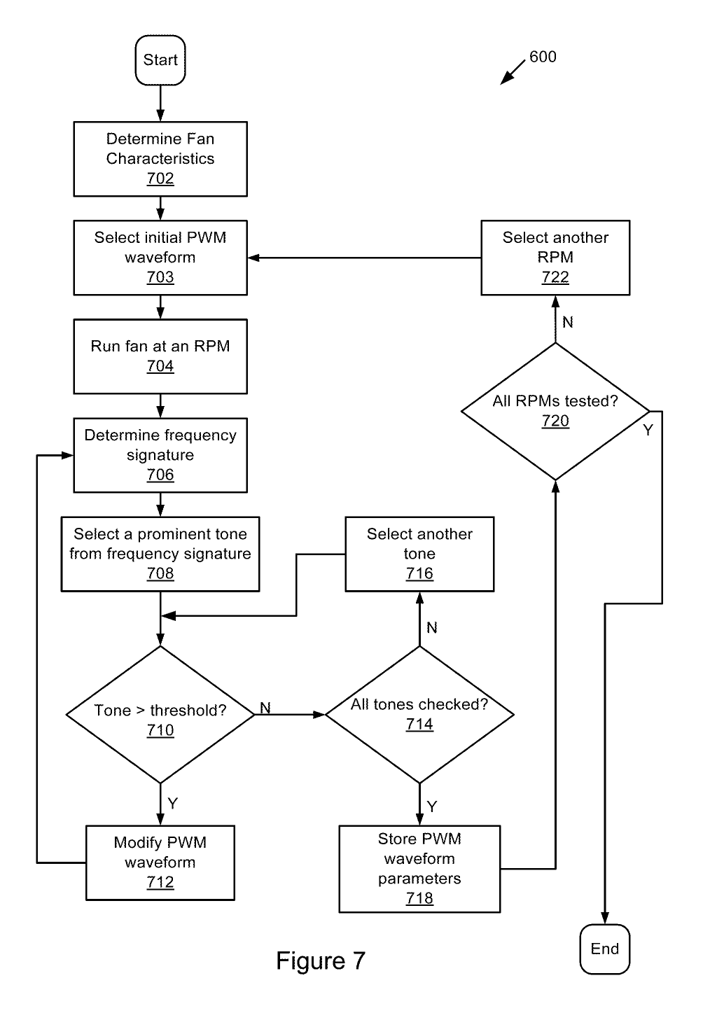

FIG. 7 is a flowchart 700 describing a process for determining non-uniform PWM waveforms for a cooling fan using equations 3 and 4 above. The process begins in step 702 where the cooling fan 508 characteristics are determined. As described above, fans often have unique construction characteristics based on number of magnet poles (N_{POLES}) and number of slots in the stator (N_{SLOTS}). If the process described in flowchart 700 occurs in a laboratory setting, then the fan characteristics may be captured from a data sheet. If the process is practiced in an assembly line setting, the cooling fan characteristics can be retrieved from a database by scanning an identifier placed on the cooling fan, such as a barcode label. Cooling fan characteristics can be used in equations 3 and 4.

In step 703 an initial PWM waveform can be selected. In one embodiment, the non-uniform PWM waveform can be determined by equations 3 and 4 above. Initial values of the scaling factors (Aₙ) can be used. For example, an initial value for A₃ can be 0.1, while A₅, A₇, A₉ etc. can be 0. The value for A1 can be fixed since it is the fundamental harmonic. Depending on a motor electro-magnetic configuration, Aₙ multipliers may be selected differently. For example, a single-phase motor design may find A₂, A₄, A₆ . . . more useful than a three-phase motor would due to the single-phase motor's asymmetric tooth design.

In step 704, the cooling fan can be run at a first operating point or speed (revolutions per minute or RPM). In step 706, the frequency signature can be determined. In one embodiment, the frequency signature can be a measurement of acoustic energy (e.g., sound pressure level) across a frequency range. The frequency signature can be captured by a stand alone microphone. If the process of flowchart 700 takes place with the cooling fans mounted in a computer system, such as a laptop, then the frequency signature can be captured with an internal laptop microphone. In one embodiment, the frequency signature can be a Fast Fourier Transform (FFT) of the audio signal captured by the microphone.

In step 708, a prominent tone from the frequency signature can be selected. The identification of tones can be made simpler if the frequency signature is the FFT of the audio signal. Also, these tones typically occur at multiples of the fan speed frequency, which can be used to help identify them. In step 710 the prominent tone can be compared to a threshold. If the prominent tone is greater than a threshold, then in step 712 the non-uniform PWM waveform can be modified. In one embodiment, the PWM waveforms can be modified by changing the scaling factors Aₙ thus adding or subtracting varying amounts of different harmonics to the non-uniform PWM waveform. After the PWM waveform is changed, the process can return to step 706 and another frequency signature can be determined.

If, in step 710, the selected tone is not greater than a threshold, then in step 714 the process determines if all the tones in the current frequency signature have been checked. If all tones have not been checked, then in step 716 another tone is selected and the process returns to step 710. If in step 714 all tones have been checked, then the non-uniform PWM waveform is stored in step 718. In one embodiment, parameters to produce the non-uniform PWM waveform can be stored in memory for later retrieval when operation of the cooling fan at the related RPM is desired. In one embodiment, the relevant coefficients for equations 3 and 4 can be stored in memory. The process proceeds to step 720 where a test determines if all operating RPMs have been tested. If more RPMs need to be tested, then in step 722 another RPM is selected. The process then proceeds to step 703. If in step 720 all RPMs have been tested, then the process ends. In another embodiment, RPMs can be tested in increments of 50 RPM. In yet another embodiment, testing time can be reduced by limiting the testing to an examination of only the first 30 harmonics of the fan speed frequency.

Although the process of flowchart 700 was described using equations 3 and 4, other PWM shaping equations can be used. For example, equations 1 and 2 can be applied. Still other voltage shaping functions can be used. For example, a continuous time varying equation wherein the voltage may be based on fan position can be used.

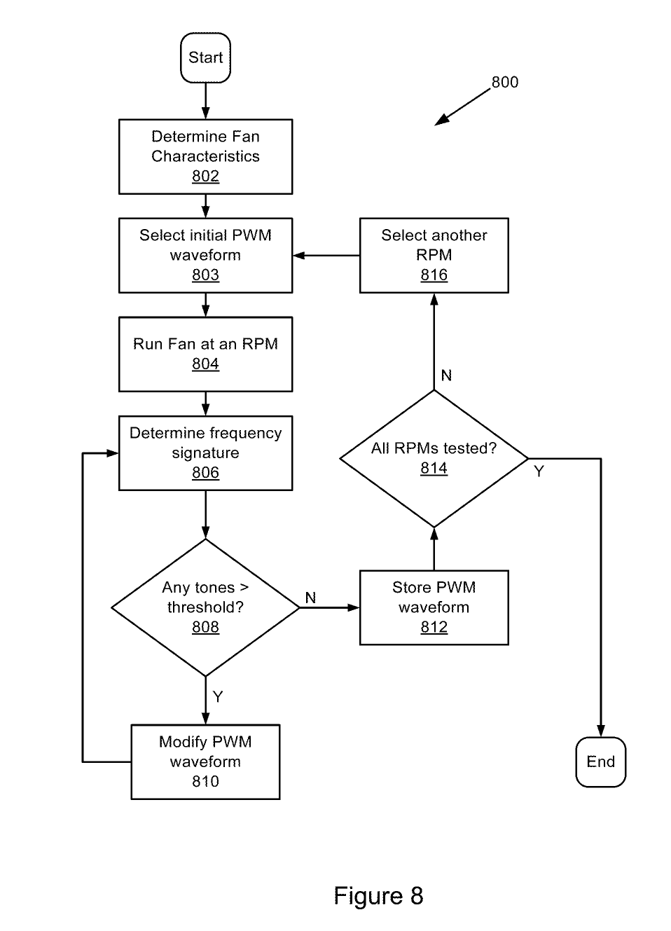

FIG. 8 is a flowchart 800 describing another process for determining PWM waveforms for a cooling fan. In this process the frequency signature can be reviewed as a whole, instead of tone by tone. The process can begin at step 802 where the cooling fan characteristics are determined. Fan construction characteristics based on number of magnet poles (N_{POLES}) and number of slots (N_{SLOTS}) can be determined in a manner similar to step 702 in FIG. 7. In step 803 an initial non-uniform PWM waveform can be selected. In one embodiment, the non-uniform PWM waveform can be determined by equations 3 and 4 above. Initial values of the scaling factors (Aₙ) can be used. This can be similar to step 403 in FIG. 4.

In step 804, cooling fan 508 is run at an RPM that is an operating point. Next, in step 806, the frequency signature can be determined. In step 808, the frequency signature can be examined as a whole and reviewed to determine if the frequency signature includes any tones that are greater than a threshold. If there are one or more tones that are greater than a threshold, then in step 810 the non-uniform PWM waveform can be modified. In one embodiment, the non-uniform PWM waveform can be modified as described in step 712 above. The process can return to step 806 and another frequency signature can be determined.

If there are no tones greater than a threshold, then in step 812 the non-uniform PWM waveform can be stored in memory. The process proceeds to step 814 where a test is made to see if all operating RPMs have been tested. If all operating RPMs have not been tested, then in step 816 another operating RPM is selected and the process returns to step 803. On the other hand, if all RPMs have been tested, then the process ends.

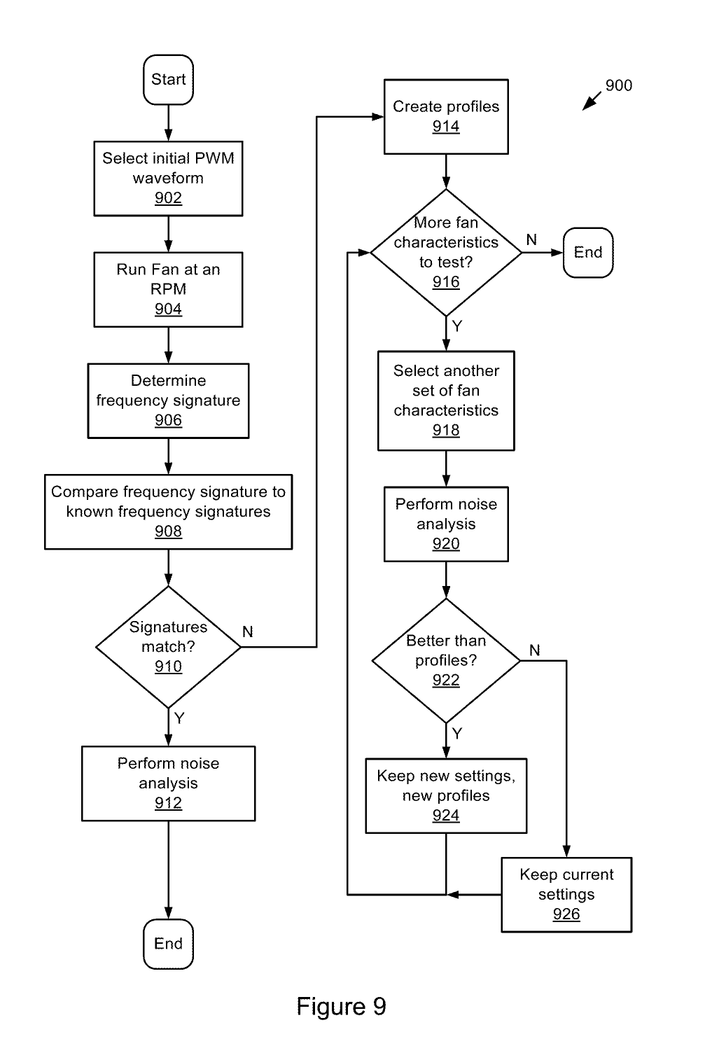

FIG. 9 is a flowchart 900 describing a process for determining non-uniform PWM waveforms for cooling fan 508, particularly when the characteristics of the cooling fan are unknown. In some scenarios, the characteristics of the cooling fan may not be available. For example, this can be the case for a cooling fan has been replaced with an unknown cooling fan in a computer system (i.e., a fan from a different supplier). The cooling fan construction characteristics (number of poles, number of slots) may not be available at test time.

The process begins at step 902 where an initial non-uniform PWM waveform is selected. This selection may be similar to step 703 described above. In step 904, cooling fan 508 is run at an initial RPM. In step 906, the frequency signature can be determined. The frequency determination can be similar to step 706 above. In step 908, the frequency signature can be compared against frequency signatures of known fans. In one embodiment, a database of known frequency signatures can be obtained from a remote server or can be stored in memory and the database can link fan characteristics (number of slots, number of poles) with frequency signatures.

If in step 910 the determined frequency signature matches a frequency signature of a known cooling fan, then the cooling fan can be identified, and the characteristics (number of slots, number of poles) of the unknown cooling fan can be identified. If the cooling fan is identified, then in step 912 noise analysis can be performed. This noise analysis can be as described in FIG. 7 or FIG. 8 or any other technologically feasible method. If, on the other hand, in step 910 the determined frequency signature does not match a stored frequency signature of a known fan, then in step 914, a profile of the frequency signatures can be created of the unknown cooling fan.

In one embodiment, the profiles can include frequency signatures of the cooling fan operating at each of the operating RPMs of the computer system. If exact fan characteristics cannot be determined from a frequency signature, then different non-uniform PWM waveforms can be applied to the cooling fan and the non-uniform PWM waveform producing the least noise can be selected and stored in memory. For example, different non-uniform PWM waveforms determined by changing the contribution of different harmonics determined by different Aₙ values can produce different non-uniform PWM waveforms to test. Creation of the profiles can enable comparisons of the noise produced by the cooling fans when operated with different non-uniform PWM waveforms.

The process can proceed to step 916 where a check is made to determine if there are more fan characteristics to test. Equations 3 and 4, for example, can determine non-uniform PWM waveforms that can be tuned for different fan characteristics (such and different N_{SLOTS} and N_{POLES}). An initial fan characteristic can be as described in step 902. Other fan characteristics can be tried in equations 3 and 4 and compared to the existing profiles. If in 916, there are more fan characteristics to be tested, then in step 918 a new set of fan characteristics are selected. For the selected fan characteristics, a noise analysis is performed in 920. This noise analysis can be as described in FIG. 7 or FIG. 8 or any other technologically feasible method.

In step 922, the frequency signatures developed during noise analysis step 920 are compared against the frequency signatures that have been previously saved. The previously saved frequency signatures are either the initial profiles (step 914) or previously saved frequency signatures saved from other previously tried non-uniform PWM waveforms that have become the current profiles. If the current frequency signatures are better than the stored profiles, then in step 924, the new fan characteristics and PWM waveform settings are stored in memory and the current profiles are saved. On the other hand, if in step 922 the current frequency signatures are not better than the stored profiles, then in step 926 the older profiles and related non-uniform PWM waveform settings are preserved. Proceeding from both step 924 and step 926, the process returns to step 916. If in step 916, there are no more fan characteristics to be tested, then the process ends.

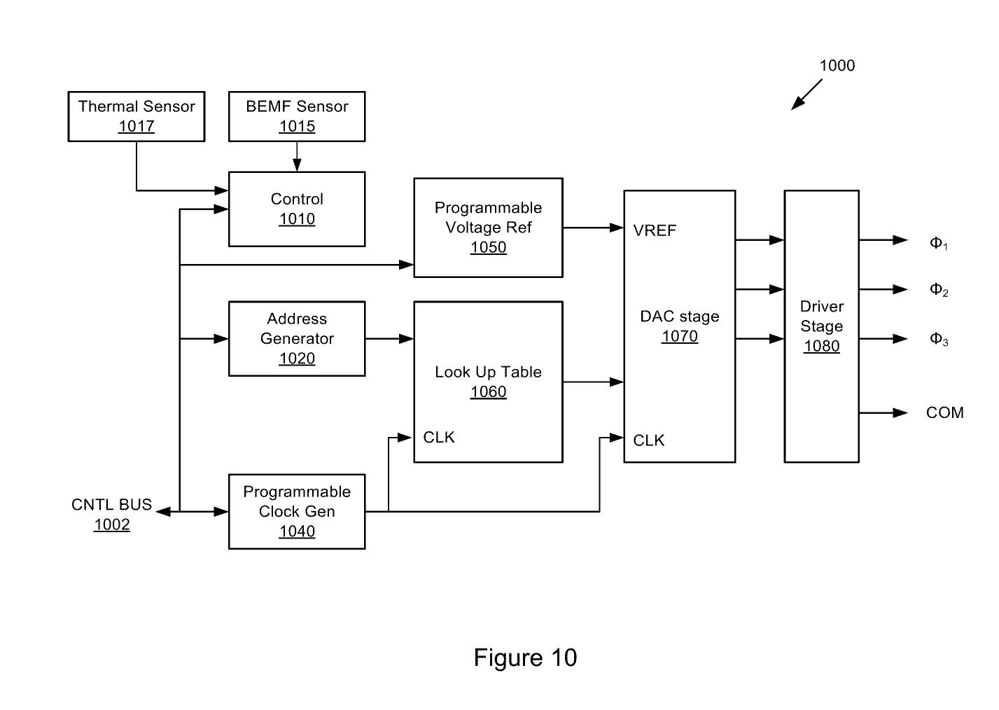

FIG. 10 is a block diagram 1000 of one embodiment of a fan controller in accordance with this specification. The fan controller can include a control block 1010, an address generator 1020, a programmable clock generator 1040, a programmable voltage reference 1050, a look up table 1060, a digital to analog converter (DAC) stage 1070 and a driver stage 1080. Manipulation of the motor drive PWM pattern can be achieved by a modification of the internal look up table memory 1060.

The control block 1010 can be coupled to a back electro-motive-force (BEMF) sensor 1015 and a thermal sensor 1017. The BEMF sensor 1015 can be used to determine fan response to driving voltages. The thermal sensor 1017 can be used to determine the temperature of an area in the computer system. The programmable clock generator 1040 can generate a clock for use by the look up table 1060 and the DAC stage 1070. The programmable address generator 1020 can produce addresses for the look up table 1060. The programmable voltage reference 1050 can provide a stable voltage reference for the DAC stage 1070. In one embodiment, commutation information, such as information shown in FIG. 2, can be included in look up table 1060. The control block can also be coupled to look up table 1060, DAC stage 1070 and driver stage 1080, however lines drawn within FIG. 10 referring to the coupling are omitted for clarity.

The control block 1010, programmable address generator 1020, programmable clock generator 1040 and programmable voltage reference 1050 can be coupled to a control bus 1002. The control bus 1002 can transfer data to and from these elements enabling a processor (not shown) to implement the disclosed methods for cooling fan control. For example, the processor can read the control block to determine BEMF and temperature data. In response, the processor can determine the DAC reference voltage through the programmable voltage reference 1050, the look up table addresses through the address generator 1020 and PWM timing characteristics through the look up table 1060 the programmable clock generator 1040.

The DAC stage 1070 can have one or more DACs. In one embodiment, the number of DACs can be determined, at least in part, by a number of phases included in the cooling fan. The output of the look up table 1060 can be coupled to the DAC stage 1070. In one embodiment, each DAC can be coupled to the driver stage 1080. In one embodiment, the driver stage 1080 can include at least one field effect transistor (FET) coupled to each cooling fan phase.

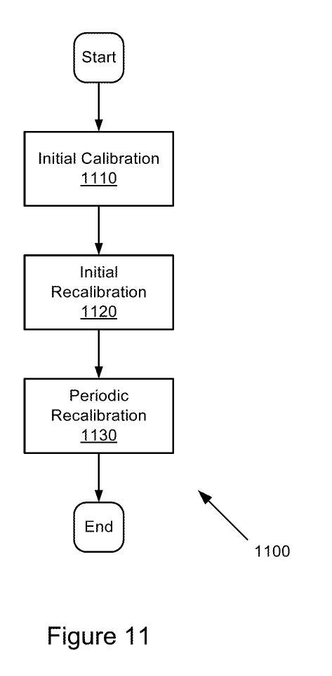

FIG. 11 shows a flowchart describing a process 1100 in which one or more of the embodiments of the described embodiments can be applied to a computer system. In 1110, the computer system can be analyzed after first assembly in a factory setting in conjunction with one of the processes described herein, such as the process described in FIG. 7 or FIG. 8. The frequency signature for the analysis can be obtained with an external, stand-alone microphone. The non-uniform PWM waveform parameters determined by this initial calibration 1110 can be stored in a non-volatile memory to be accessed later when the computer system becomes operational. Once the computer system is shipped to an end user, an initial recalibration step 1120 can be accomplished. This step may take advantage of a system microphone that can be part of the computer system. Finally in step 1130, periodic recalibration can be done at predetermined intervals or at the request of the user. Periodic recalibrations can also be triggered when the computer system detects a hardware reconfiguration.

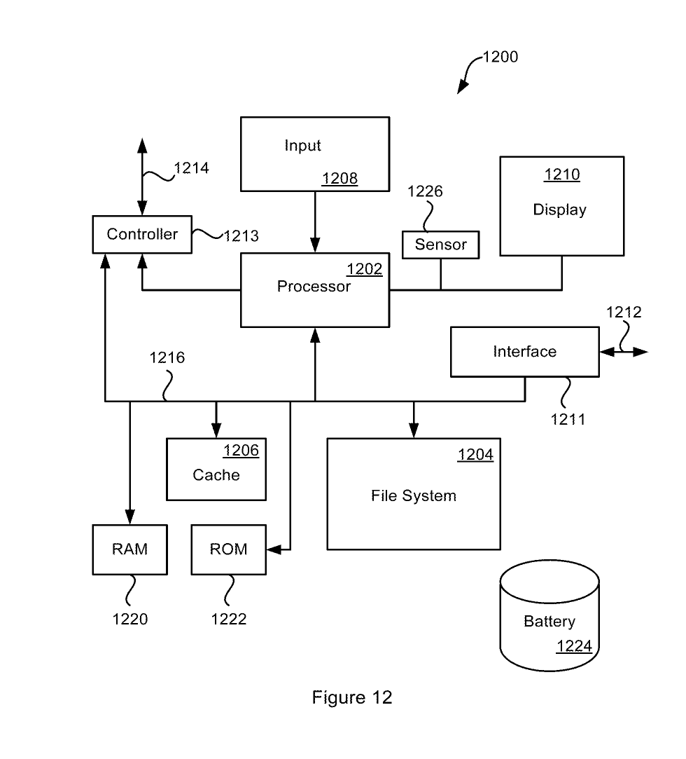

FIG. 12 is a block diagram of an electronic device suitable for controlling some of the processes in the described embodiment. Electronic device 1200 can illustrate circuitry of a representative computing device. Electronic device 1200 can include a processor 1202 that pertains to a microprocessor or controller for controlling the overall operation of electronic device 1200. Electronic device 1200 can include instruction data pertaining to manufacturing instructions in a file system 1204 and a cache 1206. File system 1204 can be a storage disk or a plurality of disks. In some embodiments, file system 1204 can be flash memory, semiconductor (solid state) memory or the like. The file system 1204 can typically provide high capacity storage capability for the electronic device 1200. However, since the access time to the file system 1204 can be relatively slow (especially if file system 1204 includes a mechanical disk drive), the electronic device 1200 can also include cache 1206. The cache 1206 can include, for example, Random-Access Memory (RAM) provided by semiconductor memory. The relative access time to the cache 1206 can be substantially shorter than for the file system 1204. However, cache 1206 may not have the large storage capacity of file system 1204. Further, file system 1204, when active, can consume more power than cache 1206. Power consumption often can be a concern when the electronic device 1200 is a portable device that is powered by battery 1224. The electronic device 1200 can also include a RAM 1220 and a Read-Only Memory (ROM) 1222. The ROM 1222 can store programs, utilities or processes to be executed in a non-volatile manner. The RAM 1220 can provide volatile data storage, such as for cache 1206

Electronic device 1200 can also include user input device 1208 that allows a user of the electronic device 1200 to interact with the electronic device 1200. For example, user input device 1208 can take a variety of forms, such as a button, keypad, dial, touch screen, audio input interface, visual/image capture input interface, input in the form of sensor data, etc. Still further, electronic device 1200 can include a display 1210 (screen display) that can be controlled by processor 1202 to display information to the user. Data bus 1216 can facilitate data transfer between at least file system 1204, cache 1206, processor 1202, and controller 1213. Controller 1213 can be used to interface with and control different manufacturing equipment through equipment control bus 1214. For example, control bus 1214 can be used to control a computer numerical control (CNC) mill, a press, an injection molding machine or other such equipment. For example, processor 1202, upon a certain manufacturing event occurring, can supply instructions to control manufacturing equipment through controller 1213 and control bus 1214. Such instructions can be stored in file system 1204, RAM 1220, ROM 1222 or cache 1206.

Electronic device 1200 can also include a network/bus interface 1211 that couples to data link 1212. Data link 1212 can allow electronic device 1200 to couple to a host computer or to accessory devices. The data link 1212 can be provided over a wired connection or a wireless connection. In the case of a wireless connection, network/bus interface 1211 can include a wireless transceiver. Sensor 1226 can take the form of circuitry for detecting any number of stimuli. For example, sensor 1226 can include any number of sensors for monitoring a manufacturing operation such as for example a Hall Effect sensor responsive to external magnetic field, an audio sensor, a light sensor such as a photometer, computer vision sensor to detect clarity, a temperature sensor to monitor a molding process and so on.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium for controlling manufacturing operations or as computer readable code on a computer readable medium for controlling a manufacturing line. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

The foregoing description, for purposes of explanation, used specific nomenclature to provide a thorough understanding of the described embodiments. However, it will be apparent to one skilled in the art that the specific details are not required in order to practice the described embodiments. Thus, the foregoing descriptions of specific embodiments are presented for purposes of illustration and description. They are not intended to be exhaustive or to limit the described embodiments to the precise forms disclosed. It will be apparent to one of ordinary skill in the art that many modifications and variations are possible in view of the above teachings.

What is claimed is:

1. A method for operating a computing system having at least one electro-mechanical component controlled by a processor, the method comprising:
prior to operating the computing system at a first operating state, characterizing a noise produced by operating the electro-mechanical component at a first operating point with a first control signal;
modifying the first control signal to a second control signal wherein the second control signal operates the electro-mechanical component in a manner to produce prominent acoustic tones less than a predetermined threshold; and,
operating the electro-mechanical component with the second control signal.

2. The method of claim 1, wherein the second control signal is a shaped non-uniform pulse width modulated (PWM) waveform.

3. The method of claim 1, wherein the characterizing comprises determining a Fast Fourier Transform (FFT) of an acoustic audio signal of the electro-mechanical component.

4. The method of claim 1, wherein the electro-mechanical component is a fan.

5. The method of claim 2, wherein the non-uniform PWM waveform is determined by a shaping function.

6. The method of claim 2, wherein control parameters related to the second control signal are stored in a memory

7. The method of claim 1, wherein the first operating state is determined by a temperature.

8. A fan controller for controlling a cooling fan for a computing system, the controller comprising:
a temperature sensor configured to determine a temperature of the computing system;
a look up table configured to include at least one a non-uniform pulse width modulated (PWM) waveform parameter;
an address generator coupled to the look up table inputs and configured to provide addresses to the look up table;
a digital to analog converter (DAC) coupled to the look up table outputs and configured to provide non-uniform PWM fan control signals in response to the look up table outputs;
a programmable voltage reference coupled to the DAC configured to provide a reference voltage for the DAC outputs; and
a controller configured to determine the non-uniform PWM fan control signal in response to the determined temperature by:
programming the address generator in accordance with the determined temperature, and
setting a programmable voltage reference in accordance with the determined temperature.

9. The fan controller of claim 8, further comprising a clock generator coupled to the look up table inputs and configured to produce a clock signal in accordance with the determined temperature;

10. The fan controller of claim 8, further comprising a driver stage coupled to the DAC outputs and configured to produce control signals for one or more phase windings of a fan.

11. The fan controller of claim 8, wherein the look up table is further configured to include two or more non-uniform waveform parameters.

12. The fan controller of claim 8, wherein the controller is further configured to modify the address generator in response to a change in determined temperature.

13. The fan controller of claim 8, wherein the look up table is further configured to include a commutation sequence.

14. A computer system including a non-uniform pulse width modulated (PWM) fan controller comprising:
a temperature sensor configured to determine the temperature of the computer system;
a cooling fan configured to move cooling air into and out of the computer system; and
a fan controller configured to control the cooling fan in response to the determined temperature with non-uniform PWM fan signals that operate the cooling fan in a manner that produces prominent tones less than a predetermined threshold acoustic threshold.

15. The computer system of claim 14, wherein the fan controller comprises a look up table configured to include non-uniform PWM parameters.

16. The computer system of claim 15, wherein the look up table is further configured to include commutation information.

17. The computer system of claim 15, wherein the look up table is further configured to include two or more sets of non-uniform PWM parameters wherein one set corresponds to one operational point of the computer system.

18. The computer system of claim 14, wherein the non-uniform PWM fan signals are determined in accordance with a shaping function.

19. Non-transient computer readable medium for storing computer code executable by a processor in a computer system for controlling a cooling fan in a computing system, the computer readable medium comprising:
computer code for determining a temperature of the computing system;
computer code for selecting parameters for a non-uniform pulse width modulated (PWM) waveform in response to the determined temperature;
computer code for generating a non-uniform PWM waveform in accordance with the selected parameters; and
computer code for operating the cooling fan with the non-uniform PWM waveform, wherein the operating produces prominent acoustic tones less than a predetermined threshold.

20. The non-transient computer readable medium as recited in claim 19, further comprising:
computer code for determining the parameters of the non-uniform PWM waveform in response to a shaping function.

21. The non-transient computer readable medium as recited in claim 19, further comprising:
computer code for storing parameters for the non-uniform PWM waveform in a look up table.

22. The non-transient computer readable medium as recited in claim 19, further comprising:
computer code for storing commutation information in a look up table.
